(19) United States
(12) Patent Application Publication
(10) Pub. No.: US 2025/0346786 A1
(43) Pub. Date: Nov. 13, 2025

(54) PERFORATED MASKING TAPE

(71) Applicants: RACHEL CAROL KOHLMEIER, WINNECONNE, WI (US); JAKE KOHLMEIER, WINNECONNE, WI (US)

(72) Inventors: RACHEL CAROL KOHLMEIER, WINNECONNE, WI (US); JAKE KOHLMEIER, WINNECONNE, WI (US)

(21) Appl. No.: 18/950,023

(22) Filed: Nov. 16, 2024

Related U.S. Application Data
(63) Continuation-in-part of application No. 17/560,864, filed on Dec. 23, 2021, now Pat. No. 12,168,742.
(60) Provisional application No. 63/131,177, filed on Dec. 28, 2020.

(51) Int. Cl. C09J 7/20; C09J 7/21; C09J 7/38

(52) U.S. Cl. CPC C09J 7/203; C09J 7/21; C09J 7/38; C09J 2301/122; C09J 2301/18

(57) ABSTRACT

A hand-tearable masking tape having a paper mask layer having a top and bottom surface, the bottom surface having a bottom adhesive layer disposed thereon. The paper mask layer and the bottom adhesive layer have a predefined width and a predefined length and includes a plurality of hole members protruding into the paper mask layer up to 300 perforations per inch (TPI), the paper mask layer further including a plurality of solid portions designed to resist tear so the paper mask layer tears along at least one or more of a width and length of a line of hole members. An adhesive compound forms the bottom adhesive layer. The plurality of hole members protrudes through the paper mask layer, the paper mask layer having a cut/tie range of 0.05 mm to 12 mm, the plurality of hole members extending through the paper mask layer, and up to the adhesive layer.

### CLAIM OF PRIORITY

This application claims the benefit of and priority to and is a continuation in part of U.S. patent application Ser. No. 17/560,864, filed on Dec. 23, 2021, which claims priority to U.S. Provisional Application with Ser. No. 63/131,177, filed on Dec. 28, 2020, both with the same title, the contents of which are hereby incorporated by reference in their entirety.

### FIELD OF THE INVENTION

The inventive concept relates generally to a perforated masking tape designed for protecting surfaces from paint and other substances.

### BACKGROUND

Currently, there are a number of solutions for a detachable covering or shielding painting tape that protects adjacent surfaces being painted or treated. One of these solutions attempts to utilize clear or transparent packing tape, but this solution fails to meet the needs of the market because clear packing tape is hard to place and remove cleanly from a surface (without damaging the underlying surface) when painting. Another solution attempts not to use tape but instead a portable shielding device or spatula-type member that is held in one hand while painting with the other. Unfortunately, this solution is similarly unable to meet the needs of the market because painting with the free hand while holding the shield member is cumbersome and inefficient when painting large areas. Further, although tearable by hand, current forms of masking tape in the market do not tear evenly from the dispenser roll or may tear prematurely from the roll, disrupting or prolonging the masking process before painting or treating a certain area with paint. Therefore, there currently exists a need in the market for an improved tape for masking certain surfaces that is easy to apply as well as peel off walls and windows when the painting project is complete.

### SUMMARY OF THE INVENTION

The inventive concept, in one example embodiment, is a masking tape that has an elongate tape member, a paper mask layer contiguously coupled by a top surface of the paper mask layer coupled to a bottom surface of the paper mask layer, a plurality of up to 300 aligned hole members parallelly disposed laterally substantially the width of, and longitudinally substantially the length of the paper mask layer. The paper mask layer includes a plurality of solid portions of the paper mask layer disposed laterally and longitudinally between the plurality of hole members designed to resist tear so the elongate tape member tears along the plurality of hole members substantially perpendicularly to longitudinal sides of the elongate tape member along a user-selected one row of a plurality of linear rows of hole members. An adhesive compound is disposed substantially on the entire bottom surface of the paper tape member.

In a related example embodiment, the masking tape includes a paper mask layer with a plurality of perforated hole members parallelly disposed laterally substantially the width of the elongate tape member and, in some embodiments, longitudinally. The paper mask layer is then coupled to an adhesive compound disposed substantially on the entire bottom surface of the paper mask layer. The lateral perforations on the paper mask layer are designed to tear perpendicularly to longitudinal sides of the elongate tape member along a user-selected one row of plurality of linear rows of hole members.

In one example embodiment of the described masking tape, up to 300 aligned hole members per inch of the polymer perforated lining member including a set of linear rows of hole members running substantially the width of the elongate tape member.

Masking tape, also known as painter's tape, is a type of pressure-sensitive tape normally made of a thin and easy-to-tear paper, and an easily released pressure-sensitive adhesive. It is available in a variety of widths. It is used mainly in painting, to mask off areas that should not be painted. The adhesive is the key element to its usefulness because it allows the tape to be easily removed without leaving residue or damaging the surface to which it is applied. Masking tape is typically available in several strengths, rated on a 1-100 scale based on the strength of the adhesive. Most painting operations will require a tape in the 50 range. Household masking tape may be made of an even weaker paper and lower-grade adhesive. The inventive perforated tape may include these strength ranges.

In various embodiments, biodegradable polymers that can be used in some embodiments are a special class of polymer that breaks down after its intended purpose by bacterial decomposition process to result in natural byproducts such as gases (CO₂, N₂), water, biomass, and inorganic salts. These polymers are found both naturally and synthetically made and largely consist of ester, amide, and ether functional groups. Their properties and breakdown mechanisms are determined by their exact structure. These polymers are often synthesized by condensation reactions, ring-opening polymerization, and metal catalysts. There are vast examples and applications of biodegradable polymers. The inventive perforated tape uses polymers as appropriate to the user's need for support.

Added is a hand-tearable masking tape that has a paper mask layer having a top surface and a bottom surface, the bottom surface having a bottom adhesive layer disposed thereon, the paper mask layer and the bottom adhesive layer having a predefined width and a predefined length and including a plurality of hole members protruding into the paper mask layer up to 300 perforations per inch (TPI), the paper mask layer further including a plurality of solid portions designed to resist tear so the paper mask layer tears along at least one or more of a width and length of a line of hole members. An adhesive compound is disposed substantially on a bottom surface of the paper mask layer, forming the bottom adhesive layer, a plurality of hole members that protrude through the paper mask layer, the paper mask layer having a cut/tie range of 0.05 mm to 12 mm, the aligned plurality of hole members extending through the paper mask layer, and up to the adhesive layer.

In some embodiments of the hand-tearable masking tape, the combination paper mask layer and the bottom adhesive layer are configured to have a sufficient length to form an elongate tape member in a dispensable roll configuration.

In some embodiments of the hand-tearable masking tape, the plurality of holes is configured in linear rows of hole members spanning at least one or more of the width and the length of the paper mask layer such that the solid portions of the paper mask layer are located therebetween, thereby facilitating the tearing of the paper mask layer substantially perpendicularly to longitudinal sides of the paper mask layer along a user-selected one of the linear rows of hole members.

In some embodiments of the hand-tearable masking tape, the adhesive compound is a pressure-sensitive adhesive. In some embodiments of the hand-tearable masking tape, the paper mask layer is formed to include a plurality of micro-ribs or micro-nubs to inhibit a lateral flow of a liquid or fluid substance across the bottom adhesive layer. In some embodiments of the hand-tearable masking tape, the liquid substance is selected from a group including paint, solvent, or water. In some embodiments of the hand-tearable masking tape, a polymer coating layer includes a plurality of microparticles to inhibit a lateral flow of a liquid or fluid substance across the bottom adhesive layer. In some embodiments of the hand-tearable masking tape, the paper mask layer includes a plurality of equally spaced markings designed to provide a user a measurement aid or tool.

Added is the hand-tearable masking tape that includes a paper mask layer having a top surface and a bottom surface, the bottom surface having a bottom adhesive layer disposed thereon, the paper mask layer and the bottom adhesive layer having the predefined width and the predefined length and including the plurality of hole members protruding through the paper mask layer up to 300 perforations per inch (TPI), the paper mask layer further including the plurality of solid portions designed to resist tear so the paper mask layer tears along the width of the line of hole members. The adhesive compound is disposed substantially on the bottom surface of the paper mask layer; wherein the top surface of the paper mask layer includes the plurality of hole members extending to and aligned with the plurality of hole members that protrude through the paper mask layer, the paper mask layer having the cut/tie range of 0.05 mm to 12 mm, the aligned plurality of hole members extending through the top layer of the paper mask layer, at least partly through the paper mask layer, and not through the bottom adhesive layer.

In some embodiments of the hand-tearable masking tape, the combination paper mask layer and the bottom adhesive layer are configured to have the sufficient length to form the elongate tape member in the dispensable roll configuration. In some embodiments of the hand-tearable masking tape, the plurality of holes is configured in linear rows of hole members spanning at least one or more of the width and length of the paper mask layer such that the solid portions of the paper mask layer are located therebetween, thereby facilitating the tearing of the paper mask layer substantially perpendicularly to longitudinal sides of the paper mask layer along the user-selected one of the linear rows of hole members.

In some embodiments of the hand-tearable masking tape, the adhesive compound is the pressure-sensitive adhesive. In some embodiments of the hand-tearable masking tape, the polymer coating layer is formed on the paper mask layer to include the plurality of micro-ribs or micro-nubs to inhibit the lateral flow of the liquid or fluid substance across the polymer coating layer. In some embodiments of the hand-tearable masking tape, the liquid substance is selected from the group including paint, solvent, or water. In some embodiments of the hand-tearable masking tape, the polymer coating layer includes the plurality of microparticles to inhibit the lateral flow of the liquid or fluid substance across the polymer coating layer. In some embodiments of the hand-tearable masking tape, at least one of the paper mask layer includes the plurality of equally spaced markings designed to provide the user the measurement aid or tool. In some embodiments of the hand-tearable masking tape, up to 300 aligned hole members per inch of the paper mask layer comprise each laterally disposed linear row of hole members running substantially the width of the elongate tape member.

Added is the method of forming the hand-tearable masking tape including providing the paper mask layer having the top surface and the bottom surface, the paper mask layer having the predefined width and the predefined length. The method includes providing the bottom adhesive layer to the bottom surface of the paper mask layer. The method includes forming the plurality of hole members protruding at least into the paper mask layer up to 300 perforations per inch (TPI), the hole members extending at least up to the bottom adhesive layer, the paper mask layer further including the plurality of solid portions designed to resist tear so the paper mask layer tears along the width of the line of hole members. The method includes providing the adhesive compound on the bottom surface of the paper mask layer.

The method may include configuring the plurality of holes in linear rows of hole members spanning the width of the paper mask layer such the solid portions of the paper mask layer are located therebetween, thereby facilitating the tearing of the paper mask layer substantially perpendicularly to longitudinal sides of the paper mask layer along the user-selected one of the linear rows of hole members.

The method may include adding the plurality of equally spaced markings designed to provide the user the measurement aid or tool.

It would be advantageous to have a masking tape that is perforated. Furthermore, it would be advantageous to have a masking tape that is durable. Still further, it would be advantageous to have a masking tape that is removable.

The inventive perforated tape advantageously fills the aforementioned deficiencies by providing masking tape, which provides a quick way to compensate for painting inaccuracies.

The described masking tape, in one embodiment, has a perforated coating. In this example embodiment, the described masking tape has a paper mask layer, which fulfills the need for removable tape. In another embodiment, the masking tape has a perforated paper layer.

Among other things, it is an advantage of the inventive perforated tape to provide masking tape that does not suffer from problems or deficiencies associated with prior solutions.

It is still further an advantage of the inventive perforated tape to be durable. Still further, the described masking tape has a poly coating. The embodiments described herein are applicable to stronger tape products such as duct tape, packing tape, or medical tape, which may still require or need hand-tearing in some cases.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates a perspective view of the inventive perforated masking tape;

FIGS. 2A-2B illustrate a top view of the inventive perforated tape;

FIGS. 3A-3B illustrate a bottom view of the inventive perforated tape;

FIG. 4 illustrates a view of a set of layers of the inventive perforated tape;

FIG. 5A-5B illustrates one of a polymer lining member or paper layer with a plurality of perforated hole members;

FIG. 6 illustrates a top view of an embodiment of the perforated masking tape;

FIG. 7 illustrates a top view of another embodiment of the perforated masking tape having a top polymer coating layer with formations for impeding liquid flow;

FIG. 8 illustrates a representative perforated masking tape section having 300 perforations per inch across the width of the masking tape; and

FIG. 9A-9B illustrates a representative method of forming a hand-tearable masking tape.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

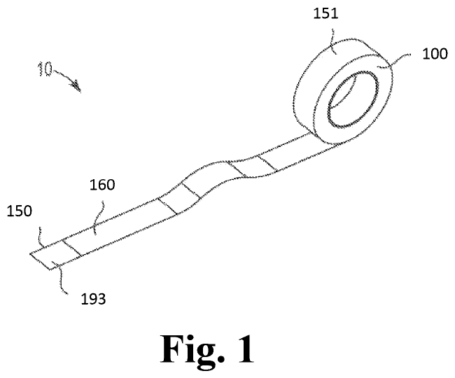

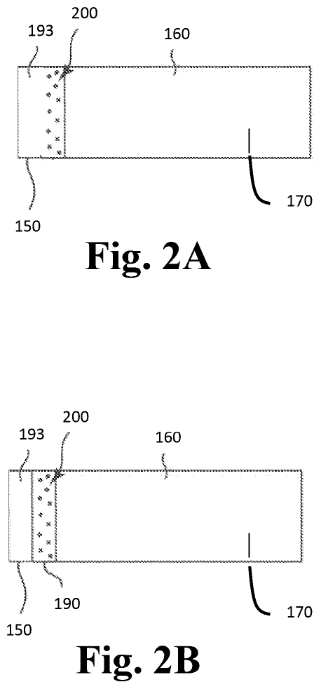

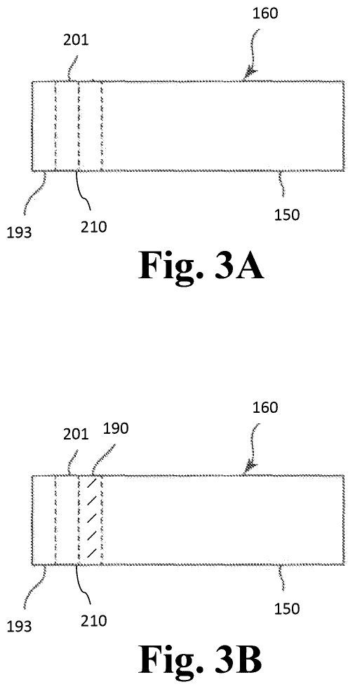

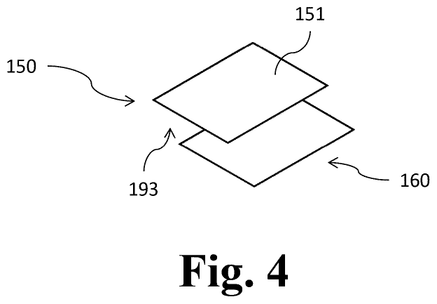

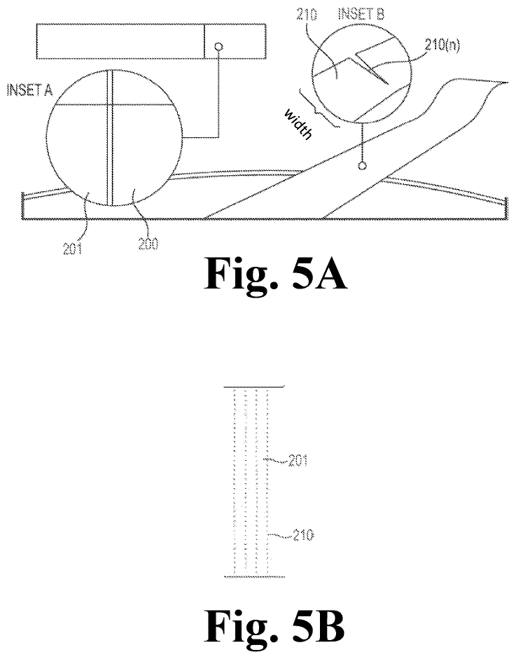

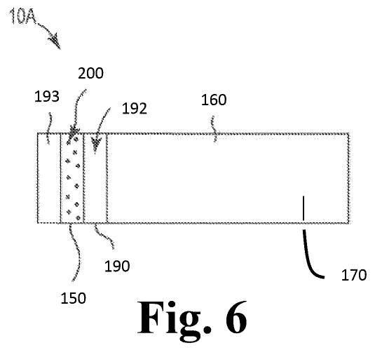

Referring to the figures, FIGS. 1-7 illustrate that the inventive perforated tape device 10 includes a masking tape embodiment that is in dispensable roll form and includes an elongate tape member 100, a paper mask layer 150 that in some embodiments may be coated by polymer coating layer 110 or contiguously coupled at a top surface 151 of the paper mask layer 150 covering or contiguously coupled to a bottom surface of the paper mask layer 193. In this example embodiment, and referring more specifically to FIGS. 4 and 5A-5B, a plurality of hole members (or perforations) 200 is parallelly disposed laterally substantially the width of, and longitudinally substantially the length of, paper mask layer 150 and, if present, substantially covering an entire polymer perforated lining member 190. Further, in some embodiments, the elongate tape member 100 when in dispensable roll form has the polymer perforated lining member 190 substantially covering the entire length of the tape member 100.

In the representative embodiment, paper mask layer 150 includes a plurality of solid portions 201 disposed laterally and longitudinally between the plurality of hole members 200 designed to resist tear so the elongate tape member 100 tears substantially perpendicularly to longitudinal sides of the elongate tape member 100 along a user-selected one row 210(n) of a plurality of linear rows of hole members 210. A bottom adhesive compound layer 160 is disposed substantially on the entire bottom surface of the paper mask layer 193.

In one embodiment of the described masking tape, hole members of up to 300 per inch comprise each laterally disposed linear row of hole members 210 running substantially the width of the elongate tape member. The limited width of these perforations must fit linearly across the perforated masking tape 100 naturally serves to diminish the porousness of liquid into the hole members 210.

Referring now to FIGS. 4-7, in other related embodiments, a hand-tearable masking tape 10A includes the paper mask layer 150 having the top surface 151, the paper mask layer 150 having a predefined width and a predefined length and including a plurality of hole members 200 protruding through the paper mask layer 150. In this example embodiment, paper mask layer 150 further includes the plurality of solid portions 201 (each with predefined lengths to provide additional strength) configured to resist an inadvertent tear so the paper mask layer 150 tears along the mask layer width of the line of hole members 210. Adjacent in some embodiments is a biodegradable polymer lining member 190 coupled to the bottom surface of the paper mask layer 193, which also provides additional strength to the paper mask layer 150 to prevent inadvertent tearing as the elongate tape 100 is pulled or extended from the dispensable roll. Finally, the bottom adhesive layer 160 is disposed on the bottom surface of the paper mask layer 193. The advantage of this example embodiment of the hand-tearable tape 10A is that there is no “bleed through” since the holes or perforations 200 are now only through the paper mask layer 150 and/or polymer film layer 190 (as an option) and not through bottom adhesive layer 160. This also ensures that the elongate tape 100 does not tear while being pulled or peeled off the roll, hence making this embodiment manufacturable utilizing standard material, tooling, and equipment.

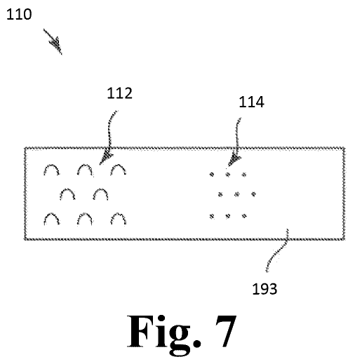

In yet another related embodiment, and referring to FIG. 7, there is illustrated a top view of an embodiment of the perforated masking tape 10B having the top polymer coating layer 110 with formations for impeding liquid flow. In particular, there is provided a masking tape 10B and a method of forming a hand-tearable masking tape 10B, including the steps of providing the paper mask layer 150 having the top surface 151 and the bottom surface of the paper mask layer 193 having the predefined width and the predefined length. The method includes forming the plurality of hole members 200 protruding through the paper mask layer 150, with the paper mask layer 150 further including the plurality of solid portions 201 designed to resist tear so the paper mask layer tears along the width of a line of hole members 210. The method includes the step of coating the top surface 151 of the paper mask layer 150 with the polymer coating top layer 110 and providing the polymer lining member 190 coupled to the bottom surface of the paper mask layer 193. The method also includes the step of providing or forming an adhesive compound layer 160 on the bottom surface of the paper mask layer 193.

In a related embodiment, the method includes forming the polymer coating layer 110 with a plurality (random or equidistantly defined) micro-nubs or micro-indents 112 to impede paint or solvent from running or dripping off the tape 100. In this example embodiment, lateral ribs or small nubs (or microribs or micronubs) 112 are in an offset pattern to ensure direct channels are not formed to facilitate the dripping or running of paint or solvent. In another related embodiment, the polymer coating layer 110 is formed with microparticles 114 to create an abrasive or rough or uneven surface to also impede paint or solvent from running or dripping off the tape. In this example embodiment, microparticles 114 are in an offset pattern to ensure direct channels are not formed to facilitate dripping or running of paint or solvent.

In yet another embodiment, the paper mask layer 150 includes a plurality of equally spaced markings 170 configured to provide a user a measurement aid or tool (similar to a tape measure) when the tape is extended from the roll and applied to a wall or other surface.

In various embodiments, the pressure-sensitive adhesives require a delicate balance of viscous and elastic properties, which result in a four-fold balance of adhesion, cohesion, stretchiness, and elasticity. Pressure-sensitive adhesives generally comprise elastomers which are either inherently tacky, elastomers or thermoplastic elastomers, which are extended with the addition of tackifying resins and plasticizing oils. They can be coated in solvent or as water-based emulsions to reduce the material viscosity to a level that is easily applied to the backing composite of the tape. An adhesive composition that is preferably comprised of a blend of an acrylic pressure-sensitive adhesive and a thermoplastic elastomer. The adhesive composition comprises at least 5 weight percent adhesive and the composition has a morphology comprising at least two distinct domains, a first domain being substantially continuous in nature and a second domain being fibrillose to schistose in nature parallel to the major surface of the adhesive within said first domain. Optionally, the adhesive is comprised of a blend of an acrylic pressure-sensitive adhesive and an elastomer and a tackifier, the composition comprising at least 5 weight percent adhesive and the composition having a morphology comprising at least two distinct domains, a first domain being substantially continuous in nature and the second domain being fibrillose to schistose in nature parallel to the major surface of the adhesive within the first domain. Major classes of pressure-sensitive adhesives useful for preparing the tape of the invention include but are not limited to natural rubbers; synthetic rubbers such as butyl rubber, and linear, radial, star, branched, and tapered block copolymers such as styrene-butadiene, styrene-ethylene/butylene and styrene-isoprene; acrylics, especially those having long chain alkyl groups; and silicones.

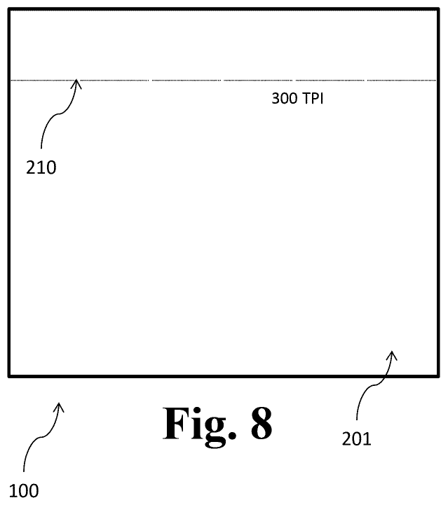

Further detailed is an embodiment of the hand-tearable masking tape 10A designed to protect surfaces from paint and other substances. The paper mask layer 150 has the top surface 151 and the bottom adhesive layer 160. The paper mask layer 150 and the bottom adhesive layer 160 having the predefined width and the predefined length and, including the plurality of hole members 210 protruding into the top surface 151 of the paper mask layer 150 greater than, as illustrated in FIGS. 8, up to 300 perforations per inch (TPI), the paper mask layer 150 further including the plurality of solid portions 201 designed to resist tear so the paper mask layer 150 tears along the width of the line of hole members 210; the bottom adhesive layer 160 disposed on the bottom surface of the paper mask layer 193; wherein the top surface 151 includes the plurality of hole members 210 extending to and aligned with the plurality of the hole members 210 that protrude through the paper mask layer 150, the paper mask layer 150 having a cut/tie range of 0.05 mm to 12 mm, the aligned plurality of hole members 210 extending through the paper mask layer 150, and up to the bottom adhesive layer 160. Cut/tie is defined as how far and how deep an associated manufacturing machine tool cuts the plurality of hole members 210. The representative embodiment illustrated 300 TPI, where a greater TPI also tends to be less pervious than comparably fewer TPI, assuming the greater TPI has smaller hole members 210.

Further detailed is an embodiment of the hand-tearable masking tape 10A has the paper mask layer 150 having the top surface 151 and the bottom surface 193, the paper mask layer 150 having the predefined width and the predefined length and including the plurality of hole members 210 protruding through the paper mask layer 150 up to 300 perforations per inch (TPI), the paper mask layer 150 further including the plurality of solid portions 201 designed to resist tear so the paper mask layer 150 tears along the width of a line of hole members 210. The polymer lining member 190, if present, may be coupled to the bottom surface of the paper mask layer 193. The adhesive compound is otherwise disposed substantially on the bottom surface of the paper mask layer 193. Included is the plurality of hole members 210 extending to and aligned with the plurality of hole members 210 that protrude through the paper mask layer 150, the paper mask layer 150 having the cut/tie range of 0.05 mm to 12 mm, the aligned plurality of hole members 210 extending through the paper mask layer 150, wherein the bottom adhesive layer 160 is designed to prevent bleed through.

While the inventive perforated tape 100 has been described above in terms of specific embodiments, it is to be understood that the inventive perforated tape 100 is not limited to these disclosed embodiments. Upon reading the teachings of this disclosure many modifications and other embodiments of the inventive perforated tape 100 will come to mind of those skilled in the art to which this inventive perforated tape 100 pertains, and which are intended to be and are covered by both this disclosure and the appended claims. It is indeed intended that the scope of the inventive perforated tape 100 should be determined by proper interpretation and construction of the appended claims and their legal equivalents, as understood by those of skill in the art relying upon the disclosure in this specification and the attached drawings.

FIG. 8 illustrates representative perforated masking tape sections having 300 perforations per inch across the width of the perforated tape 100. (Note: these perforations are designed to be evenly distributed across the width of the paper, and limitations on printing and drawing software will not actually be able to show 300 perforations.)

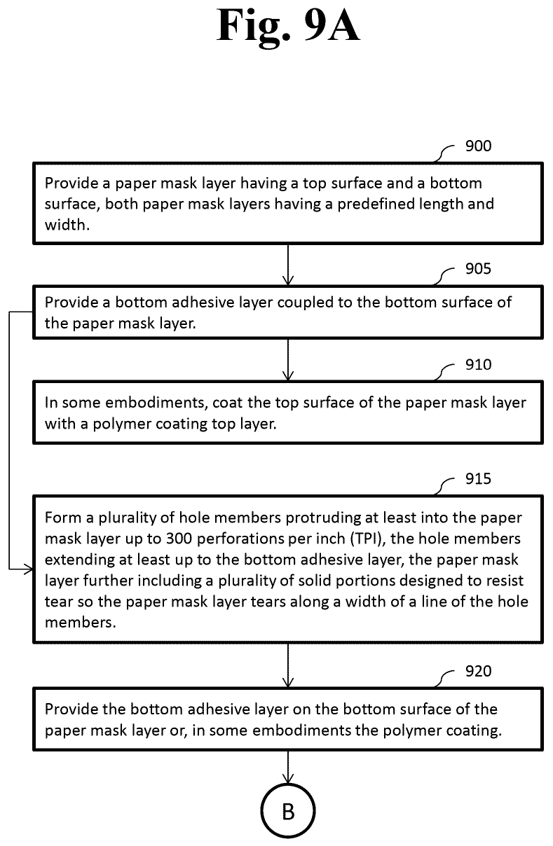

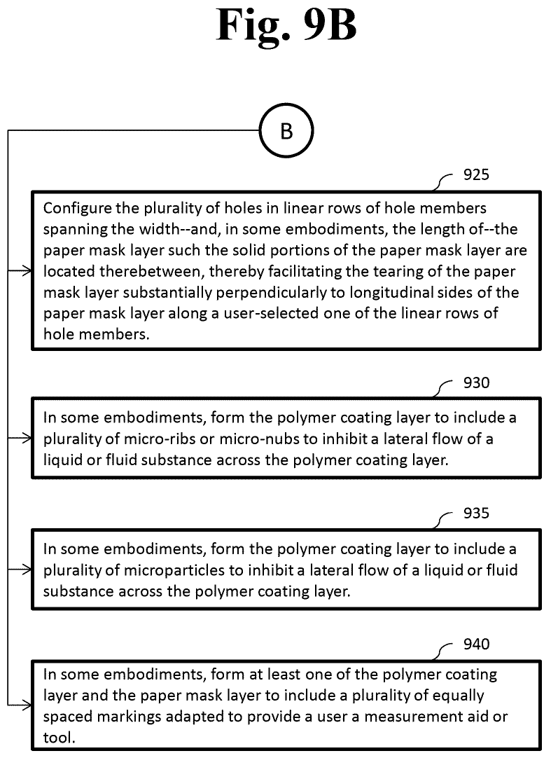

FIGS. 9A-9B illustrate a method embodiment of forming the hand-tearable masking tape 10A comprising the steps of 900, providing the paper mask layer 150 having the top surface 151 and the bottom surface of the paper mask layer 193 having the predefined width and the predefined length. Included is the step of 905, providing the bottom adhesive layer 160 coupled to the bottom surface of the paper mask layer 193. Included is the optional step of 910, coating the top surface 151 of the paper mask layer with the polymer coating top layer. Included is the step of 915, forming the plurality of hole members 210 protruding at least into the paper mask layer up to 300 perforations per inch (TPI), hole members 210 extending at least up to the bottom adhesive layer 160, the paper mask layer 150 further including the plurality of solid portions 201 designed to resist tear so the paper mask layer 150 tears along the width of the line of the hole members 210. Included is the step of 920, providing the bottom adhesive layer 160 on the bottom surface of the paper mask layer 193.

Included may be the step of 925, comprising the step of configuring the plurality of holes in linear rows of hole members 210 spanning the width-and in some embodiments the length-of the paper mask layer 150 such that the solid portions 201 of the paper mask layer 150 are located therebetween, thereby facilitating the tearing of the paper mask layer substantially perpendicularly to longitudinal sides of the paper mask layer along the user-selected one of the linear rows of hole members 210. Included may be the step of 930, forming the polymer coating layer to include the plurality of micro-ribs or micro-nubs to inhibit the lateral flow of the liquid or fluid substance across the polymer coating layer 110. Included may be the step of 935, forming the polymer coating layer to include the plurality of microparticles 114 to inhibit the lateral flow of the liquid or fluid substance across the polymer coating layer 110. Included may be the step of 940, forming at least one of the polymer coating layer 110 and the paper mask layer to include the plurality of equally spaced markings 170 designed to provide the user the measurement aid or tool.

It is an object of the invention, therefore, to include straight edges both inherently along the edges of the paper mask layer 150 and along tears along edges created by the holde members 210.

The following patents and publications are incorporated by reference in their entireties: U.S. Pat. Nos. 5,985,775; 9,095,877; 9,550,877; and U.S. Pub. 20080286533M.

1. A hand-tearable masking tape comprising:
a paper mask layer having a top surface and a bottom surface, the bottom surface having a bottom adhesive layer disposed thereon, the paper mask layer and the bottom adhesive layer having a predefined width and a predefined length and including a plurality of aligned hole members protruding into the paper mask layer up to 300 perforations per inch (TPI), the paper mask layer further including a plurality of solid portions adapted to resist tear so the paper mask layer tears along at least one or more of a width and a length of a line of hole members;
an adhesive compound disposed substantially on the bottom surface of the paper mask layer, forming the bottom adhesive layer, a plurality of hole members that protrude through the paper mask layer, the paper mask layer having a cut/tie range of 0.05 mm to 12 mm, the plurality of hole members extending through the paper mask layer, and up to the adhesive layer.

2. The hand-tearable masking tape of claim 1 wherein the combination paper mask layer and the bottom adhesive layer are configured to have a sufficient length to form an elongate tape member in a dispensable roll configuration.

3. The hand-tearable masking tape of claim 1 wherein the plurality of holes is configured in linear rows of hole members spanning at least one or more of the width and the length of the paper mask layer such that the solid portions of the paper mask layer are located therebetween, thereby facilitating the tearing of the paper mask layer substantially perpendicularly to longitudinal sides of the paper mask layer along a user-selected one of the linear rows of hole members.

4. The hand-tearable masking tape of claim 1 wherein the adhesive compound is a pressure-sensitive adhesive.

5. The hand-tearable masking tape of claim 1 wherein the paper mask layer is formed to include a plurality of micro-ribs or micro-nubs to inhibit a lateral flow of a liquid or fluid substance across the bottom adhesive layer.

6. The hand-tearable masking tape of claim 5 wherein the liquid substance is selected from a group including paint, solvent, or water.

7. The hand-tearable masking tape of claim 1 wherein a polymer coating layer includes a plurality of microparticles to inhibit a lateral flow of a liquid or fluid substance across the bottom adhesive layer. 8 The hand-tearable masking tape of claim 1 wherein the paper mask layer includes a plurality of equally spaced markings adapted to provide a user a measurement aid or tool. 9 A hand-tearable masking tape comprising:
a paper mask layer having a top surface and a bottom surface, the bottom surface having a bottom adhesive layer disposed thereon, the paper mask layer and the bottom adhesive layer having a predefined width and a predefined length and including a plurality of aligned hole members protruding through the paper mask layer up to 300 perforations per inch (TPI), the paper mask layer further including a plurality of solid portions adapted to resist tear so the paper mask layer tears along a width of a line of hole members;
an adhesive compound disposed substantially on the bottom surface of the paper mask layer;
wherein the top surface of the paper mask layer includes a plurality of hole members extending to and aligned with the plurality of hole members that protrude through the paper mask layer, the paper mask layer having a cut range of 0.05 mm to 12 mm, the plurality of hole members extending through the top surface of the paper mask layer, and at least partly through the paper mask layer.

10. The hand-tearable masking tape of claim 9 wherein the combination paper mask layer and the bottom adhesive layer are configured to have a sufficient length to form an elongate tape member in a dispensable roll configuration.

11. The hand-tearable masking tape of claim 9 wherein the plurality of holes is configured in linear rows of hole members spanning at least one or more of the width and length of the paper mask layer such that the solid portions of the paper mask layer are located therebetween, thereby facilitating the tearing of the paper mask layer substantially perpendicularly to longitudinal sides of the paper mask layer along a user-selected one of the linear rows of hole members.

12. The hand-tearable masking tape of claim 9 wherein the adhesive compound is a pressure-sensitive adhesive.

13. The hand-tearable masking tape of claim 9 wherein the polymer coating layer is formed on the paper mask layer to include a plurality of micro-ribs or micro-nubs to inhibit a lateral flow of a liquid or fluid substance across a polymer coating layer.

14. The hand-tearable masking tape of claim 13 wherein the liquid substance is selected from a group including paint, solvent, or water.

15. The hand-tearable masking tape of claim 9 wherein a polymer coating layer includes a plurality of microparticles to inhibit a lateral flow of a liquid or fluid substance across the polymer coating layer.

16. The hand-tearable masking tape of claim 9 wherein the paper mask layer includes a plurality of equally spaced markings adapted to provide a user a measurement aid or tool.

17. The hand-tearable masking tape of claim 11 wherein at least 240 aligned hole members per inch of the paper mask layer comprise each laterally disposed linear row of hole members running substantially the width of the elongate tape member.

18. A method of forming a hand-tearable masking tape comprising the steps of:
providing a paper mask layer having a top surface and a bottom surface, the paper mask layer having a predefined width and a predefined length;
providing a bottom adhesive layer to the bottom surface of the paper mask layer;
forming a plurality of aligned hole members protruding at least into the paper mask layer up to 300 perforations per inch (TPI), the hole members extending at least up to the bottom adhesive layer, the paper mask layer further including a plurality of solid portions adapted to resist tear so the paper mask layer tears along a width of a line of hole members; and
providing an adhesive compound on the bottom surface of the paper mask layer.

19. The method of claim 18 further comprising the step of configuring the plurality of holes in linear rows of hole members spanning the width of the paper mask layer such the solid portions of the paper mask layer are located therebetween, thereby facilitating the tearing of the paper mask layer substantially perpendicularly to longitudinal sides of the paper mask layer along a user-selected one of the linear rows of hole members.

20. The method of claim 18 further comprising the step of forming the paper mask layer to include a plurality of equally spaced markings adapted to provide a user a measurement aid or tool.
